(19) United States
(12) Patent Application Publication
(10) Pub. No.: US 2016/0092919 A1
(43) Pub. Date: Mar. 31, 2016

(54) METHOD AND APPARATUS FOR PLACING ADVERTISEMENTS ON A MOBILE DEVICE

(71) Applicant: Loopwirez, Inc., Wilmington, DE (US)

(72) Inventors: Lonnie D. Coleman, JR., Hercules, CA (US); Charles T. Marshall, Atherton, CA (US)

(73) Assignee: Loopwirez, Inc.

(21) Appl. No.: 14/502,858

(22) Filed: Sep. 30, 2014

(51) Int. Cl. G06Q 30/02; G06F 3/0484; G06F 3/0481

(52) U.S. Cl. CPC G06Q 30/0255; G06F 3/04817; G06F 3/04842; G06Q 30/0267

(57) ABSTRACT

The present invention discloses a platform to track and collect data throughout a user's engagement with a mobile device independent of user engagement with any one app. The user may transition between apps without closing an opened app or returning to a home screen. The user engagement data across the apps may be used by data analytics to target ads for the user. The data analytics analyzes the user engagement data to discern the user's interest to generate the targeted ads. The present invention also discloses a platform to deliver and display dynamic, targeted ads on a mobile device at all times, even when the user transitions between apps, or is on the home screen and disengaged from all apps. The targeted ads are displayed more timely in an ergonomically accessible manner to capture a user's attention, increasing the chance of user response and the return on investment for advertisers.

### BACKGROUND OF THE INVENTION

1. Field of the Invention

The present invention relates to methods and apparatuses for interfacing with a user on a mobile device. In particular, the present invention relates to methods and apparatuses for delivering and placing contextual contents such as advertisements, applications, or messages on a mobile device based on user engagement with the mobile device.

2. Description of Related Art

The ubiquity of mobile devices such as smart phones and tablets offers unparalleled marketing opportunities for vendors of products and services. Vendors may tailor mobile advertisements (ads) to a user based on how the user interacts with a mobile device. Presently, advertisers may leverage a user's engagement with a mobile application (app) or a web browser to deliver ads. For example, when the user opens up a mobile app or a browser, advertisers may place banner ads in a non-intrusive area within the app or the browser. One limitation of this mode of advertising is that the delivery of ads is predicated on the user's engagement with the particular app or the browser. When the user closes the app or the browser, the advertising opportunity is lost. Advertisers may attempt to leverage multiple apps to deliver ads. However, this increases the cost to advertisers and does not overcome the dependence of advertisers on the user engaging with the apps. Even if the advertiser can deliver ads when the user is not engaged with any app or browser, it may be difficult to locate an area on the home screen to non-intrusively display the ads. Further compounding the problem is that advertisers are increasingly using sophisticated data analytics on user engagement to optimize targeted advertising. When user engagement data is predicated on the user's engagement with an app, information on how the user interacts with other apps is not available, severely limiting the effectiveness of the data analytics. As such, it is desirable to provide a more effective platform to collect and analyze user engagement on a mobile device, and to deliver and display targeted mobile ads on the mobile device.

### SUMMARY OF THE INVENTION

The present invention provides a platform to collect data throughout a user's engagement with a mobile device independent of user engagement with any one app. The user engagement data may be used by data analytics to target mobile ads to the user. The present invention also provides a platform to deliver and display dynamic, targeted ads on a mobile device at all times, even when the user transitions between apps, or is on the home screen and disengaged from all apps.

According to one embodiment of the present invention, data on user engagement throughout a user's interaction with a mobile device is sent to a dashboard for analysis. For example, not only are information on user engagement with an app or a browser tracked and collected, but information on how the user transitions from app to app, or how the user engages with the home screen while disengaged from apps are sent to the dashboard. User engagement between apps is tracked and collected by a platform that makes other apps available within an opened app. The user may transition between apps by opening a second app without closing a first app. The apps whose user engagement data is tracked and collected need not share an application program interface (API) or may not be related in other ways. The dashboard has a global view of user engagement with the mobile device and may analyze the collected data to optimize the contextual message to target the user.

According to one embodiment of the present invention, the dashboard delivers targeted, contextual ads for display in a non-intrusive and ergonomically accessible part of the display of the mobile device. The ads may be displayed within an opened app or on the home screen when all apps are disengaged. For example, an ad for downloading an app may display next to a related app in an arc interface area of the home screen for easy access by the user. From within an app, an ad or message based on user activity not associated with the opened app may also display in an arc area of the opened app. In one embodiment, multiple ads or messages may display in one offering to facilitate user interaction.

The advantages of the present invention are that user engagement is tracked, collected, and analyzed independently of apps or browsers to optimize targeted contextual ads or messages that are more relevant. The targeted ads or messages are also displayed more timely in an ergonomically accessible manner to capture a user's attention, increasing the chance of user response and the return on investment for the advertisers.

### BRIEF DESCRIPTION OF THE DRAWINGS

The accompanying drawings are provided together with the following description of the embodiments for a better comprehension of the present invention. The drawings and the embodiments are illustrative of the present invention, and are not intended to limit the scope of the present invention. It is understood that a person of ordinary skill in the art may modify the drawings to generate drawings of other embodiments that would still fall within the scope of the present invention.

FIG. 1 shows the tracking of user engagement across apps and a user interface on a mobile device used to display contextual ad according to one embodiment of the present invention;

FIG. 2 shows the tracking and analysis of user engagement across apps by a dashboard to generate a targeted contextual ad according to one embodiment of the present invention;

FIG. 3 shows the delivery of multiple ads by the dashboard based on an analysis of user engagement across apps according to one embodiment of the present invention; and

FIG. 4 shows the display of an ad in an arc of the display that is ergonomically accessible by the user according to one embodiment of the present invention.

### DETAILED DESCRIPTION

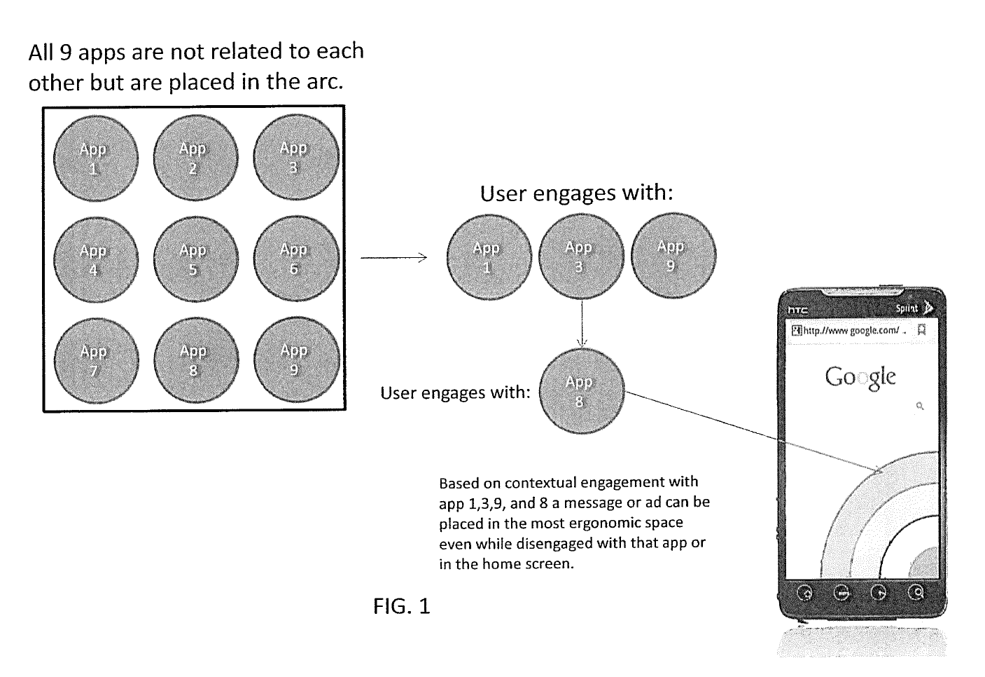

The following paragraphs describe several embodiments of the present invention in conjunction with the accompanying drawings. It should be understood that the embodiments are used only to illustrate and describe the present invention, and are not to be interpreted as limiting the scope of the present invention. FIG. 1 shows the tracking of user engagement across apps on a mobile device and the display of contextual ads according to one embodiment of the present invention. In a user interface, icons for apps are arranged in one or more quarter-circle concentric arcs near a corner of the display. The apps may be a web browser, a file manager, a text messaging tool, a social media site, or any other programs, tools, or services on the mobile device. Only a subset of the apps may be visible in the arcs at a time and a user may cycle through the apps to bring additional apps into view. The apps may be organized by categories for ease of access by placing apps of the same category on the same arc.

The arcs of apps may be visible from any screen, either from within an active app or from the home screen. The user may thus be able to open a new app or to return to a previously opened app from an active app without the need to close the active app or to return to the home screen. For example, nine apps, designed app1 through app9, may be visible in the arcs. App1 through app9 need not share resources, data and other information through an API, may not invoke each other's functionalities or be related in other ways. The user may invoke app1, app3, app9, and app8 to have all four apps opened simultaneously. User engagement across the four apps are tracked and collected. For example, app1 may be an app for making travel reservations, app3 may be an app for travel research, app8 may be a search engine, and app9 may be a social media site used by the user to exchange travel suggestions with friends. The user may interact with the four apps to plan a vacation. The user's engagement with any one app may not give sufficient insight into the user's destination preference. However, when the user's engagement with all four apps is analyzed, a data analytics tool may discern the user's preference. An advertiser such as a travel agent may use the result to generate a promotion targeted to the user's destination preference. The ad may be placed in a non-intrusive and ergonomically accessible area of the screen. FIG. 1 shows that the ad may be placed in an outer arc in the opened app8. In one embodiment, the ad may be placed in an opened app not associated with the activity from which the ad was generated (e.g., app1, app3, app9, and app8). In another embodiment, the ad may be placed on the home screen. The user may select the ad to obtain details about the offer.

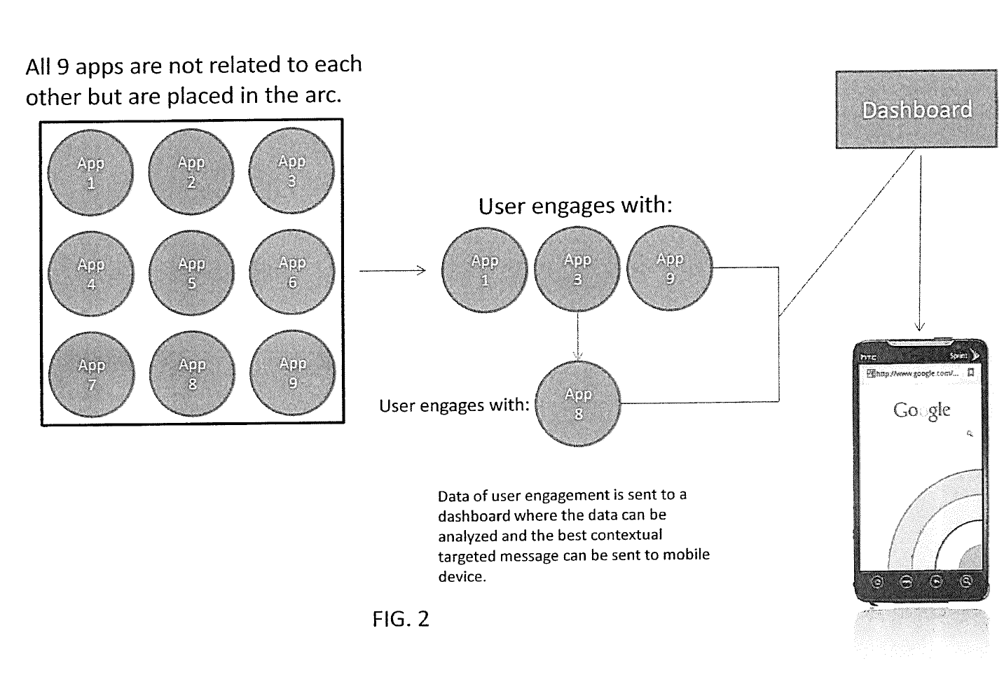

FIG. 2 shows the tracking and analysis of user engagement across apps by a dashboard to generate targeted contextual ad according to one embodiment of the present invention. Continuing with the example of FIG. 1, data analytics software on the dashboard may analyze the user engagement data across app1, app3, app9, and app8 to generate the ad from the travel agent targeted to the user. The dashboard may run on a server of a service provider. In one embodiment, all or part of the dashboard may run on the mobile device. A data logging software on the mobile device may track and collect user engagement data across the apps and may transmit the user engagement data to the dashboard for analysis. The user engagement data may include how the user interacts with the app. For example, for the travel reservation app of app1, the user engagement data may include user inquiries on the cost of airfare, lodgings, or sightseeing packages for a number of destinations for a range of dates, the number of inquiries for each destination, the amount of time spent on each destination, etc. For the travel research app of app3, the user engagement data may include user inquiries on the activities available for each destination, the travel discussion forums researched by the user, the amount of time the user researched each destination, etc. For the search engine of app8, the user engagement data may include the search terms used, the web sites viewed, the links selected, etc. For the social media site of app9, the user engagement data may include the inquiries to friends, suggestions received from friends, the profiles of accounts visited, etc. In addition, the data logging software may collect information on how the user transitions between the apps.

The data analytics of the dashboard analyzes the user engagement data to discern the user's vacation plan including the destination, dates, budget, activities, etc. A travel agent website may mine the results from the data analytics to generate ads targeted to the user. In one embodiment, the dashboard may transmit the user's vacation plan to the travel agent. The travel agent may tailor a promotional campaign such as ads, messages, apps, links, or other services addressing the user's vacation plan. The dashboard may receive the promotional information from the travel agent and may transmit the promotional information to the mobile device for display. The mobile device may place icons for the ads, messages, apps, links, or other services in one of the arcs for easy access by the user from any app or from the home screen. The use may tap on the icons to view the ads, download the apps, open the links, or to invoke services offered by the travel agent.

In another example, the dashboard may analyze the preference of the user for an app. The provider of the app may use the user preference information to launch a targeted branding campaign. For example, the data logging software may track the time duration, the frequency, and the details of the user's interaction with two social media apps, designated app2 and app4. The data analytics software may analyze the user engagement information to determine the usage pattern of app2 and app4. The data analytics software may determine that the user prefers app2 when reaching out to a group of contacts sharing a first characteristic and prefers app4 when reaching out to a second group of contacts sharing a second characteristic. A provider of app2 may use the results to launch a targeted branding campaign to promote the use of app2 for reaching out to contacts having the second characteristic. Similarly, a provider of app4 may use the results to promote the use of app4 for reaching out to contacts having the first characteristic. A provider of a new social media app may launch a branding campaign promoting the use of the new app for reaching out to contacts having either the first or second characteristic. The mobile device may display an ad for downloading the new app next to app2 or app4 on the home screen. In one embodiment, the mobile device may display the ad for downloading the new app in an arc within an opened app2 or app4. Thus, by analyzing user engagement across apps, the dashboard may tailor ads to better address the needs of the user, increasing the chance that the user will respond to the ads.

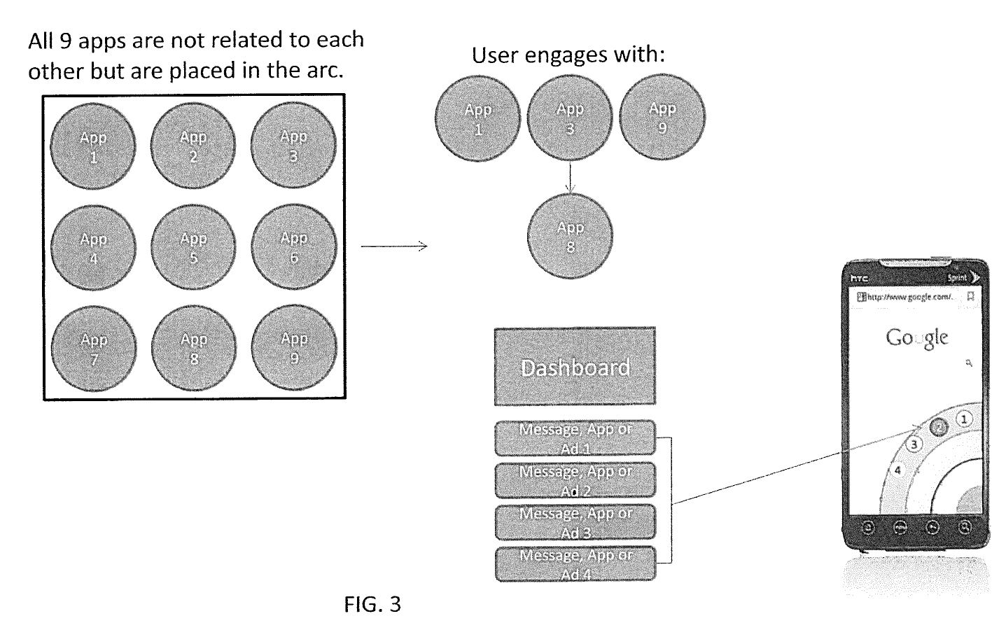

FIG. 3 shows the delivery of multiple ads by the dashboard based on an analysis of user engagement across apps according to one embodiment of the present invention. The dashboard may provide a platform for advertisers to store a library of ads. Based on the results from the data analytics, the dashboard may select ads from the library for distributing to the user. In one embodiment, the dashboard may communicate the results of the data analytics to servers operated by the advertisers for the advertiser servers to tailor the targeted ads. The advertiser servers may transmit the targeted ads to the dashboard for distribution to the mobile device of the user.

Continuing with the example of FIG. 1 and FIG. 2, the dashboard may distribute four ads, messages, apps, links, or other services from multiple advertisers to the mobile device. The advertisers may co-promote their goods and services to increase their collective appeal. For example, the first offering may be an ad for a travel package to a foreign destination that may appeal to the user; the second offering may be an app for learning the language at the destination; the third offering may be a message from a visa service provider containing information on the visa requirement for visiting the destination; and the fourth offering may be a link to a discussion forum on the destination. The mobile device may place the icons for the four offerings in an outer arc of the arcs of apps within the opened app8. The user may tap the icons to view the ad, download the app, read the message, or open the link. In one embodiment, the mobile device may place icons for the four offerings in an outer arc within another app or on the home screen.

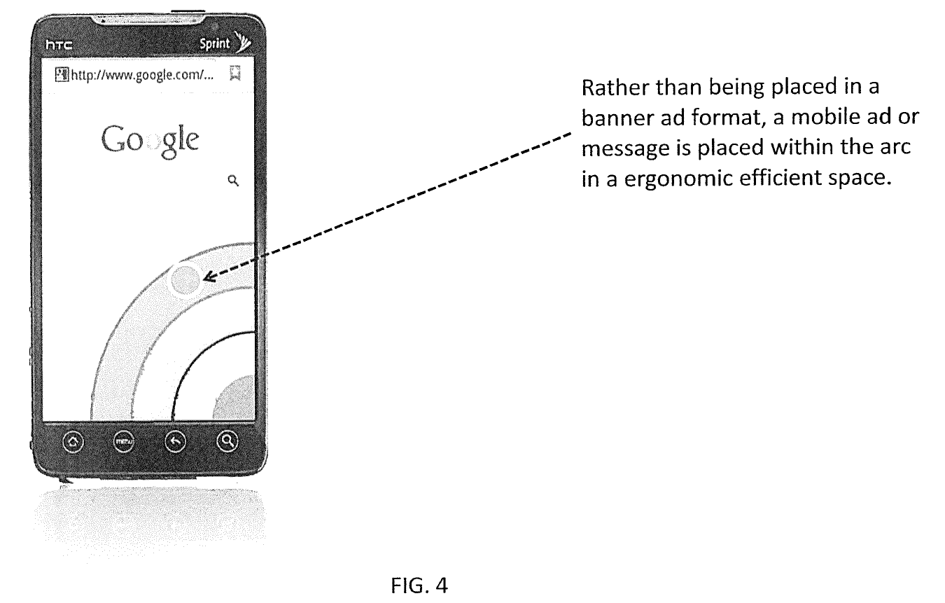

FIG. 4 shows the display of an ad in an arc of the display that is ergonomically accessible by the user according to one embodiment of the present invention. The concentric arcs may display apps of different categories. An outer arc may display icons for targeted offerings from the advertisers. If there are more icons for targeted advertiser offerings than are visible in the arc, the user may thumb scroll the outer arc ergonomically to bring additional icons into view. The icons may appear in the arc for a predetermined period of time before being removed from the arc. In addition, the mobile device may track and collect user engagement with the advertiser offerings, just like the mobile device may track and collect user engagement with installed apps. The dashboard may analyze the user engagement data with the advertiser offerings to gain additional insight into the user's interests and may further refine the advertiser offerings to increase the appeal to the user.

The descriptions set forth above are provided to illustrate one or more embodiments of the present invention and are not intended to limit the scope of the present invention. Although the invention is described in details with reference to the embodiments, a person skilled in the art may obtain other embodiments of the invention through modification of the disclosed embodiment or replacement of equivalent parts. It is understood that any modification, replacement of equivalent parts and improvement are within the scope of the present invention and do not depart from the spirit and principle of the invention as hereinafter claimed.

What is claimed is:

1. A method for delivering targeted ads to a mobile device, comprising:
displaying on the mobile device a plurality of icons associated with a plurality of mobile applications (apps) for a user to select to engage with the associated apps;
collecting data on the user's engagement across the plurality of apps;
transmitting the user engagement data to a dashboard for an analysis to generate one or more targeted ads;
receiving from the dashboard the targeted ads; and
displaying on the mobile device an icon for each of the targeted ads wherein the icons for the targeted ads are selectable by the user to engage with the targeted ads.

2. The method of claim 1, wherein said displaying on the mobile device the plurality of icons associated with the plurality of apps comprises displaying the plurality of icons from any app that is opened or from a home screen of the mobile device.

3. The method of claim 2, wherein said displaying on the mobile device the plurality of icons associated with the plurality of apps comprises displaying the plurality of icons in one or more concentric arcs.

4. The method of claim 2, wherein said displaying on the mobile device the plurality of icons associated with the plurality of apps allows the user to select from within an opened first app an icon for a second app to engage with the second app without closing the first app.

5. The method of claim 4, wherein said displaying on the mobile device the plurality of icons associated with the plurality of apps allows the user to select from within an opened second app an icon for the first app that is still opened to engage again with the first opened app.

6. The method of claim 1, wherein said collecting data on the user's engagement across the plurality of apps comprises collecting user engagement data on apps wherein the apps are not associated with one another.

7. The method of claim 1, wherein the user engagement data on the user's engagement with the plurality of apps comprises a length of time the user engages with each of the plurality of apps.

8. The method of claim 1, wherein the dashboard runs data analytics on the user engagement data to generate information pertaining to the user's interest.

9. The method of claim 8, wherein the targeted ads are generated based on the information pertaining to the user's interest.

10. The method of claim 8, wherein the information pertaining to the user's interest comprises a preference of the user for using an app.

11. The method of claim 1, wherein said displaying on the mobile device an icon for each of the targeted ads comprises displaying the icons for the targeted ads from any app that is opened or from a home screen of the mobile device.

12. The method of claim 11, wherein said displaying the icons for the targeted ads comprises displaying the icons in a concentric arc.

13. The method of claim 11, wherein an icon for one of the targeted ads comprises an icon to download an app.

14. The method of claim 1, further comprising:
collecting data on the user's engagement with the targeted ads; and
transmitting the user engagement data on the targeted ads to the dashboard for an analysis to generate one or more additional targeted ads.

15. A method for delivering targeted ads to a mobile device, comprising:
receiving by a server engagement data on a user's engagement across a plurality of mobile applications (apps) on the mobile device;
running data analytics on the user engagement data to generate information pertaining to the user's interest;
generating the targeted ads based on the information pertaining to the user's interest; and
transmitting the targeted ads to the mobile device for selectable viewing by the user on the mobile device.

16. The method of claim 15, wherein said generating the targeted ads comprises selecting the targeted ads from a library of ads based on the information pertaining to the user's interest.

17. The method of claim 15, wherein said generating the targeted ads comprises transmitting the information pertaining to the user's interest to an advertiser server and receiving from the advertiser server the targeted ads.

18. The method of claim 15, wherein the information pertaining to the user's interest comprises a preference of the user for using an app.

19. The method of claim 15, wherein said receiving by the server engagement data on the user's engagement across a plurality of apps on the mobile device comprises apps that are not associated with one another.

20. The method of claim 15, further comprising:
receiving engagement data on the user's engagement with one or more of the targeted ads;
running data analytics on the user engagement data with the targeted ads to generate additional information pertaining to the user's interest;
generating additional targeted ads based on the additional information pertaining to the user's interest; and
transmitting the additional targeted ads to the mobile device for selectable viewing by the user on the mobile device.
